(19) United States
(12) Patent Application Publication
(10) Pub. No.: US 2017/0186029 A1
(43) Pub. Date: Jun. 29, 2017

(54) ADVERTISEMENT RELEVANCE SCORE USING SOCIAL SIGNALS

(71) Applicant: Facebook, Inc., Menlo Park, CA (US)

(72) Inventors: Cassidy Jake Morris, San Francisco, CA (US); Max Christian Eulenstein, San Francisco, CA (US); Tanmoy Chakraborty, San Mateo, CA (US); Joshua Elliot Geller, Palo Alto, CA (US); Nikola Mihajlovic, Palo Alto, CA (US)

(21) Appl. No.: 14/983,449

(22) Filed: Dec. 29, 2015

(51) Int. Cl. G06Q 30/02; G06Q 50/00

(52) U.S. Cl. CPC G06Q 30/0243; G06Q 30/0275; G06Q 50/01

(57) ABSTRACT

An online system, such as a social networking system, displays a plurality of advertisements to users. The system selects an ad to display to a user based on a bidding system. The system receives feedback and user engagement data for an ad to compare the ad to other ads that are targeted to a similar group of users, to generate a relevance score. The relevance score can be provided to an advertiser as a way to quantify the effectiveness of the ad, and it reflects user engagement with the advertisement. In some embodiments, a projected relevance score can be calculated for a prospective advertisement by analyzing the content of the prospective ad prior to receiving user engagement data by comparing the prospective advertisement's content to other ads for which user engagement data does exist.

### BACKGROUND

This invention relates generally to quantifying the effectiveness of advertisements in an online system, such as a social networking system, and more particularly to evaluating such effectiveness based on user interactions with an advertisement.

Advertisement effectiveness is challenging to measure. When advertisers place advertisements for a user of an online system, such as a social networking system, the advertiser can select a bid and can designate the advertisement to target particular types of users using information known about the users. An advertiser may target, for example, users within a given age group and with a given gender. When advertisements are provided to users, an advertiser may be able to readily determine the quantity of advertisements shown to its target audience, and whether users in the target audience clicked on an advertisement. However, it is often difficult to determine how well an advertisement is engaging users relative to other advertisements for that target audience.

### SUMMARY

An online system, such as social networking system, may display a plurality of ads to users and log user feedback and interaction with each ad. The feedback and user engagement information of each ad can be compared to the user interaction history of other ads in order to generate a relevance score that is indicative of the ad's user engagement. The relevance score may be calculated by comparing an ad's user engagement to that of other ads that target the same or similar group of users. In an ad marketplace in which the ads are presented to users based on advertiser-specified bids, the relevance score can be provided to an advertiser as a way to quantify the effect of an ad's content on user engagement while mitigating the effect of differing bids. In some embodiments, a projected relevance score can be calculated by analyzing the content of an ad and comparing the ad's content to other ads that do have user engagement data and for which relevance scores are available.

### BRIEF DESCRIPTION OF THE DRAWINGS

FIG. 1 is a high level block diagram of a system environment in which a social networking system operates, in accordance with an embodiment.

FIG. 2A illustrates a user interface which displays user-generated content and ads to a user of the social network, in accordance with an embodiment.

FIG. 2B illustrates a dropdown menu with which a user can leave feedback on an ad, in accordance with an embodiment.

FIG. 3 is a functional block diagram of a method for generating a relevance score for an ad, in accordance with an embodiment.

FIG. 4A illustrates a table of bid values calculated for a single ad auction, in accordance with an embodiment.

FIG. 4B illustrates a table of bid values calculated to generate per-auction relevance scores for ads that bid in a single auction, in accordance with an embodiment.

FIG. 5 illustrates a user interface which displays ad performance metrics to an advertiser, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

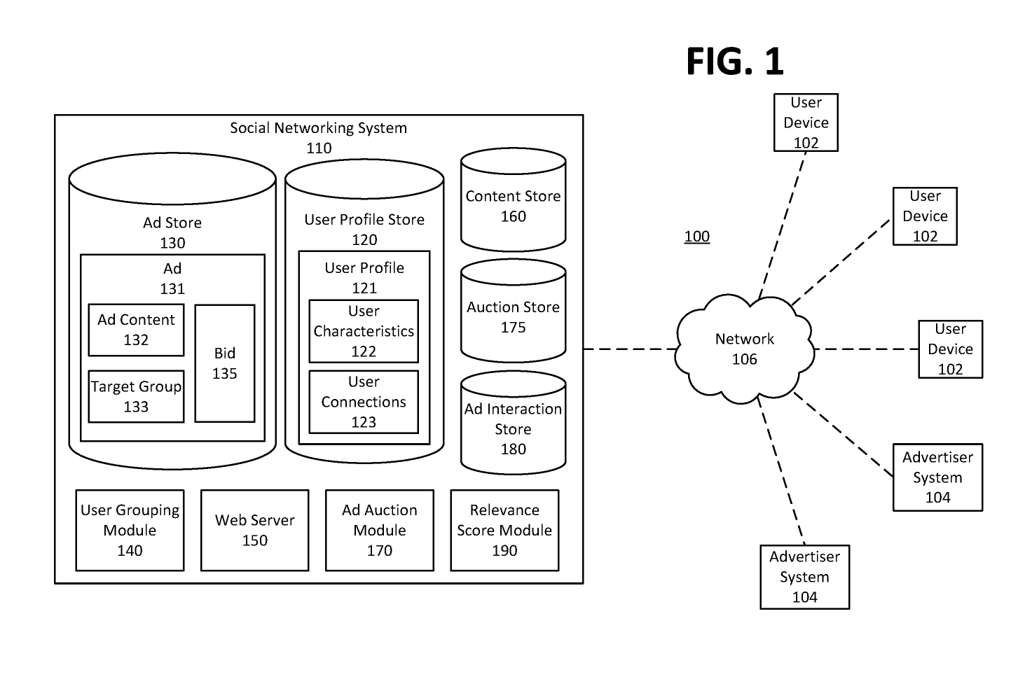

FIG. 1 is a high level block diagram of a system environment 100 for a social networking system 110. The system environment 100 includes the social networking system 110, one or more user devices 102, one or more advertiser systems 104, and a network 106. The social networking system 110 allows a plurality of users to interact with one another through a network 106. Each user is associated with a user profile and interacts with the social networking system 110 via a user device 102. Users can upload messages, comments, digital images, or videos, which can then be viewed by other users in the social networking system 110. In alternative configurations, different or additional components may be included in the system environment 100. The social networking system 110 includes an ad store 130, a user profile store 120, a user grouping module 140, a web server 150, a content store 160, an ad auction module 170, an auction store 175, an ad interaction store 180, and a relevance score module 190. The embodiments described herein can be adapted to online systems that are not social networking systems, and the embodiments may generally be used to determine the relative relevance of advertisements on other types of systems. However, for the sake of illustration, a social networking system is used as an example throughout.

The user devices 102 communicate with the social networking system 110 through a network 106. A user device 102 is a computing system capable of receiving user input and transmitting or receiving data via the network 106. In one embodiment, a user device 102 is a conventional computer system, such as a desktop or laptop computer. Alternatively, a user device 102 may be a device having computer functionality, such as a personal digital assistant (PDA), a mobile telephone, a smartphone or another suitable device. A user device 102 is configured to communicate via the network 106. In one embodiment, a user device 102 executes an application allowing a user of the user device 102 to interact with the social networking system 110. For example, a user device 102 may execute a browser application to enable interaction between the user device 102 and the social networking system 110 via the network 106. In another embodiment, a user device 102 interacts with the social networking system 110 through an application programming interface (API) running on a native operating system of the user device 102, such as IOS® or ANDROID™.

The user devices 102 are configured to communicate via the network 106, which may comprise any combination of local area and/or wide area networks, using both wired and/or wireless communication systems. In one embodiment, the network 106 uses standard communications technologies and/or protocols. For example, the network 106 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 106 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 106 may be represented using any suitable format, such as hypertext markup language (HTML) or extensible markup language (XML). In some embodiments, all or some of the communication links of the network 106 may be encrypted using any suitable technique or techniques.

In general, one or more advertiser systems 104 also communicate with the social networking system 110 through the network 106, although, in some embodiments, an advertiser system 104 may communicate with the social networking system 110 through a separate network. An advertiser system 104 may be any device or set of devices capable of communicating with the social networking system 110, such as one or more servers, a personal computer, or a mobile device. An advertiser system 104 is a computing system capable of transmitting or receiving data via the network 106. An advertiser system 104 may be, for example, a desktop or laptop computer, one or more servers, or a consumer mobile device. An advertiser system 104 communicates with the social networking service 110 to provide one or more advertisements for the social networking system 110 to provide to users of the social networking system 110. As further described below, the social networking service 110 provides the advertiser system 104 with information indicative of the performance of the ads of the advertiser system 104. In general, an advertiser system 104 is operated by one or more advertisers. An advertiser is an entity which creates one or more ads and pays the social networking system 110 to display the ads to users of the social networking system 110.

The social networking system 110 shown in FIG. 1 includes a user profile store 120, an ad store 130, a user grouping module 140, a web server 150, a content store 160, and a relevance score module 190. In other embodiments, the social networking system 110 may include additional, fewer, or different components for various applications. Conventional components such as network interfaces, security functions, load balancers, failover servers, and management and network operations consoles are not shown so as to not obscure the details of the system architecture.

Each user of the social networking system 110 is associated with a user profile, which is stored in the user profile store 120. FIG. 1 shows only a single user profile 121 for illustrative simplicity. In general, a user interfaces with the social networking system 110 via a user device 102 by providing user authentication details for the user's user profile to the social networking system 110. The user authentication details may be stored on the user device 102 or input by the user into the user device 102.

The user profile 121 includes user characteristics 122. User characteristics 122 include declarative information about the user that was explicitly shared by the user and may also include profile information inferred by the social networking system 110. In one embodiment, the user characteristic 122 includes multiple data fields, each describing one or more attributes of the corresponding user of the social networking system 110. Examples of user characteristics 122 stored in the user profile 121 include biographic, demographic, and other types of descriptive information, such as work experience, educational history, gender, hobbies or preferences, and geographic locations. The user profile 121 may also store other information provided by the user, for example, images or videos. In certain embodiments, images may be tagged with identification information of users of the social networking system 110 displayed in an image. The user profile 121 may also maintain references to actions by the corresponding user performed on content items in the content store 160.

The user profile 121 also includes user connections 123. User connections 123 include one or more references to other user profiles (not shown in FIG. 1) in the user profile store 120 that the user profile 121 is connected to. The user connections 123 may include a connection between two user profiles 121 which is based on a received indication to form such a connection, received from one or both of the two users. Herein, a user profile 121 connected to another user profile in this way is denoted as a “friend” of that user. The user connections 123 may also include connections between users generated automatically based on interactions between the two users on the social networking system 110. User connections 123 may also include the connections of a user profile 120 to a profile or a page on the social networking system 110 of a business. For example, an advertiser system 104 may control such a business profile or business page.

The content store 160 stores objects that each represent various types of user-generated content. Examples of user-generated content represented by an object include a page post, a status update, a photograph, a video, a link, a shared content item, a gaming application achievement, a check-in event at a local business, a brand page, or any other type of content. Social networking system users may create objects stored by the content store 160, such as status updates, photos tagged by users to be associated with other objects in the social networking system, events, groups or applications. In some embodiments, objects are received from third-party applications or third-party applications separate from the social networking system 110. In one embodiment, objects in the content store 160 represent single pieces of content or content “items.” Hence, users of the social networking system 110 are encouraged to communicate with each other by posting text and content items of various types of media through various communication channels. This increases the amount of interaction of users with each other and increases the frequency with which users interact within the social networking system 110.

While user profiles in the user profile store 120 are frequently associated with individuals, allowing individuals to interact with each other via the social networking system 110, user profiles may also be stored for entities such as businesses or organizations. This allows an entity to establish a presence on the social networking system 110 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The social networking system 110 also contains an ad store 130, which stores a plurality of ads. An ad 131, which is stored in the ad store 130, may have ad content 132, a target group 133, and a bid 135. FIG. 1 shows only a single ad 131, but the ad store 130 may contain many ads, each with ad content, a target group, and a bid. An ad 131 can be presented to a user by presenting the ad content 132. The ad content 132 specifies what to present to the user, which can include text, a video, a sound file, an image, and metadata specifying how to display the various components, among other things. The ad content 132 may also include a network address, such as a URL or an address of a page on the social networking service 110, which links to additional content to present. The linked content at the network address can be accessed by the user by clicking, tapping, or otherwise interacting with a portion of the ad 131. The ad content 132 may also specify the type of the ad 131. The type of an ad 131 (the “ad type”) can specify where it is displayed on a web page or application, the size of the ad 131, how a user can interface with an ad 131, the type of user device 102 that the ad 131 can be displayed to, and valid content items that the ad 131 can contain (e.g., images, text, video). The ad content 132 may also contain details about the time that an ad 131 should be displayed. The time may be a time of day, a day of the week, or a date range.

An ad 130 also has an associated target group 133. The target group 133 specifies the subset of the total set of all user profiles to which the ad should be presented. In one embodiment, the subset is specified by defining target user parameters, wherein each user profile of the social networking system 110 is in the group if and only if each target user parameter matches a user characteristic stored in association with the user profile. The target user parameters can also specify a range of user characteristics, in which case each user profile is included in the group if and only if the corresponding user characteristic of the user profile is within the range of user characteristics specified by the target user parameter. For example, the user parameters of a target group 133 can specify that it contains users who are women between ages 30-40. The target group will then include the set of user profiles that indicate in their respective user characteristics that the associated user is both a woman and between the ages of 30 and 40. Some embodiments allow for a Boolean algebra expression constructed of atomic user characteristics for defining whether a user is in the group. For example, a target group can be defined such that it contains all men between 21-40 years old who have expressed interest in either long distance running or weight lifting (i.e. if [(is male) AND (is between 21-40 years old) AND ((has interest in weight lifting) OR (has interest in long distance running))] evaluates to TRUE for a given user profile, then that user profile is include in the group). Though described above as indicating users belong to a target group 133, in various embodiments a user is not determined to be within the target group 133 until an opportunity to present an advertisement to the user is identified. In this case, when the opportunity occurs, the user characteristics 122 of the user are compared with target user parameters to determine whether the user may be targeted by the ad 131. In alternate embodiments, the target group 133 of an ad 131 specifies an index which corresponds to a group of users.

A social networking system 110 can establish a bidding structure to determine which advertisement to present when there is an opportunity to present an advertisement to a user. In such an embodiment, an ad 135 has a bid 135 which can be set by the associated advertiser system 104. In some embodiments, the bid 135 is a maximum bid. The bid 135 may also define an action which triggers the advertiser system 104 to pay the social networking system 110, also denoted herein as the “bid goal” of the ad. If the bid goal is an impression of the ad (i.e., displaying the ad to a user), then the social networking system 110 is paid by the advertiser system 104 whenever the ad content 132 is displayed to a user. Alternately, the bid 135 may be predicated on a specific user interaction (i.e., payment is received by the social networking system 110 whenever a user interacts with the ad in a predefined manner). This user interaction may be clicking on the ad content 132, accessing content linked by the ad content 132, downloading an application associated with the ad 131, purchasing an item in an online market, signing up for a subscription based service, providing positive feedback to a page on the social networking system 110, instructing the social networking system 110 to share the ad 131 or a page with other users who are associated with the user (e.g., share the ad with “friends” of the user), or some other interaction. In some embodiments, when the ad 131 is clicked or tapped on, the social networking system 110 routes the user to a web page or a page in the social networking system 110. The social networking system 110 can record the user's interaction with this page and a certain interaction or a certain set of interactions can be considered the action of the bid 135. For example, a user can be considered to have performed an action if the user views a page for a threshold number of seconds, performs a transaction on the page, initiates an installation of a software application via the page, RSVPs for an event, signs up for a service, or some other interaction. In some embodiments, the user interaction is reported to the social networking system 110 by a third party service which may be controlled by the advertiser system 104 associated with the ad 131.

The user grouping module 140 builds a group by determining the set of users which correspond to a set of user parameters to identify a set of users related to an advertisement or to evaluate an advertisement's effectiveness. The group may be the target group of the ad 131. The set of parameters for a group may be specified by the target group 133 of an ad 131. The user grouping module 140 generates the target group 133 of the ad 131. In other embodiments, the users may be dynamically targeted for an advertisement when an opportunity to provide an ad is received by the social networking system 110. In these embodiments, the user grouping module 140 may determine groups when an advertisement is analyzed for its relevance score as further described below. The user grouping module 140 can dynamically generate a group based on group parameters. The user grouping module 140 may also store static groups which have set user parameters. The static groups of the user grouping module 140 can be updated periodically with new user information or updated immediately whenever a user profile changes. In some embodiments, the user grouping module 140 determines whether individual users are in a group, rather than creating and storing groups.

The ad auction module 170 selects among multiple ads to determine the ad to display to the user for a given advertising placement (e.g., an advertising slot or space in a page). When the web server 150 receives a request for content (e.g., a request for a webpage) from a user device 102, the web server 150 routes a request to the ad auction module 170 for selection of one or more ads. The request from the web server 150 specifies the user profile or user characteristics of the user associated with the request for an ad. The request may further specify the type of ad. Each ad of applicable ad type which has the requesting user in its target group may compete in an auction to determine which ad will be displayed to a user. The ad auction module 170 determines which ad to display based on the bid 135 of each ad and the historic feedback and user interaction of the ad.

In some embodiments, the ad auction module 170 calculates a total bid for each ad. The total bid may be a combination of an estimated cost per impression (eCPI) and an organic score. The eCPI is the estimated payout to the social networking system 110 for displaying the ad based on the ad's bid and the bid goal. eCPI may also be based on the historic conversion rate (i.e., the rate at which the action identified by the ad's bid goal is performed by a user to whom the ad is displayed). The organic score is indicative of the relevance of the ad to users in its target group based on stored user interactions with the ad, and represents a value to the user without respect to payment by the advertiser for the placement of the advertisement. The organic score may be calculated specifically for each user profile for each advertisement competing in an auction. The ad auction module 170 may also determine the amount to be paid by the advertiser system 104 whose ad wins the auction. The operation of the ad auction module 170 is further described below.

The auction store 175 stores information relating to each auction processed by the ad auction module 170. The ad auction store 175 stores, for each auction, the eCPI, the organic score, and the total bid for each ad that competes in the auction. The auction store 175 may also store the winning bid, the winning ad, and the rank of each ad's total bid. The auction store 175 may also store an indication of the time of the auction and an identifier for the user profile for which the auction was performed.

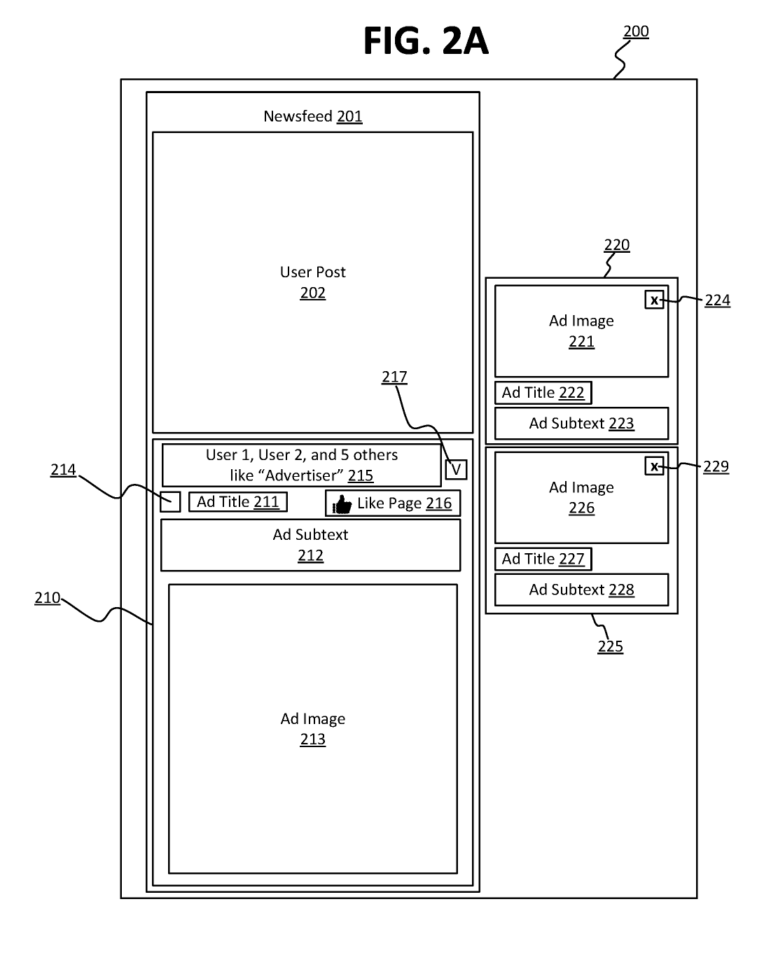

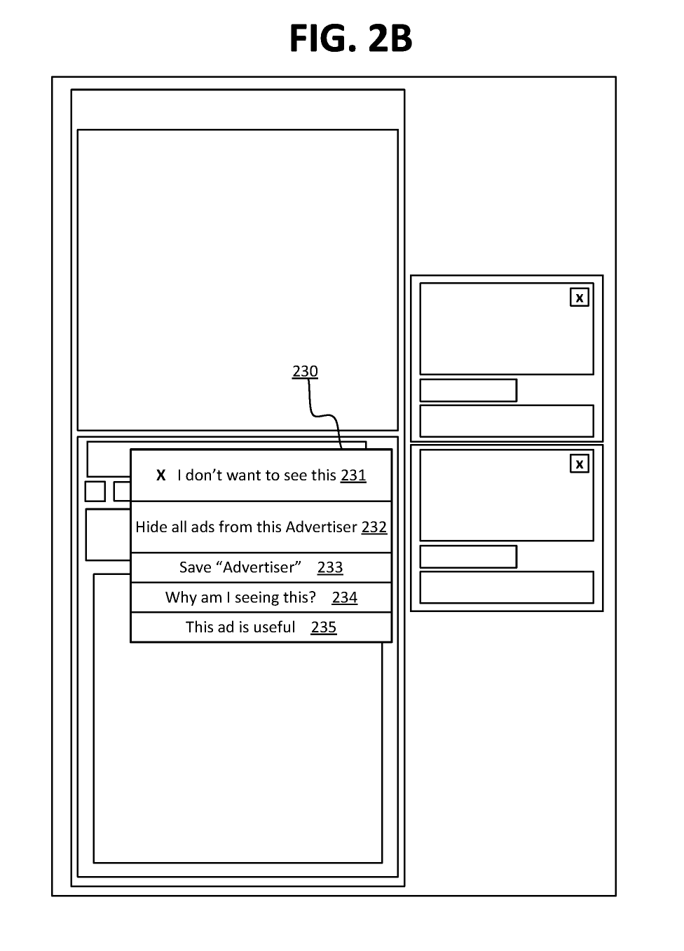

The user interaction store 180 stores details about user interactions with one or more ads. These details may be logs of user feedback separated into individual user interactions, each corresponding to a distinct impression. Each impression is a single instance in which an ad (e.g. ad 131) is displayed to a user (e.g., user profile 121). Each user interaction stored in the ad interaction store 180 may comprise a number of interaction parameters indicative of the user's interest or lack thereof in the displayed ad. Interaction parameters correspond to logged interactions with advertisements, which may be positive or negative. For example, clicking on an ad 131 is a positive interaction and pressing a button on the ad 131 to remove the ad from display is a negative interaction. A user interaction parameter may indicate the reception from a user of a “social signal”: an indication that associates the user with the ad 131, a webpage associated with the ad 131, a page associated with the ad 131 on the social networking system 110, or a profile associated on the social networking system 110 with the ad 131. The social signal may also trigger the social networking system 110 to display the ad 131 to users connected to the user social networking system 110. One or more of the interaction parameters may correspond to the bid goal of the ad 131. User interaction parameters are discussed further in conjunction with FIGS. 2A and 2B.

In some embodiments, the ad interaction store 180 also stores statistics on user feedback and interactions. In one embodiment, the ad interaction store 180 stores the number of users that the ad 131 was displayed to along with the number of those users who clicked on the ad 131, commented on the ad 131, or provided feedback on the ad 131. In an alternate embodiment, the ad interaction store 180 stores the percentage or ratio of users who interacted with the ad 131 in a certain way. In some embodiments, the user interaction parameters for each user interaction are stored in association with weights related to the individual users to whom the user interaction corresponds (i.e., the user the ad was displayed to when generating the impression). These weights may designate whether that interaction should be accorded higher or lower weight based on the particular user (e.g., negative feedback from a user who frequently gives negative feedback to ads might be weighted less heavily than the same type of negative feedback from a user who rarely provides negative feedback). In some embodiments, the user interaction store 180 stores, in association with each user interaction, a reference to the ad (e.g., ad 131) that was displayed and a reference to the user (e.g., user profile 121) to which the ad was displayed. The ad store 130 may store references in association with each of the stored ads to the user interactions corresponding to the ad stored in the ad interaction store 180. Similarly, the user profile store 120 may store references to the ad interaction store 180 corresponding to the user interactions presented to each user.

The web server 150 links the social networking system 110 via the network 106 to the one or more user devices 102. The web server 110 serves web pages, as well as other web-related content, such as JAVA®, FLASH®, XML, and so forth. The web server 150 may receive and route messages between the social networking system 110 and the user device 102, for example, instant messages, queued messages (e.g., email), text messages, short message service (SMS) messages, or messages sent using any other suitable messaging technique. A user may send a request to the web server 150 to upload information (e.g., images or videos) that are stored in the content store 160. Additionally, the web server 150 may provide application programming interface (API) functionality to send data directly to native client device operating systems, such as IOS®, ANDROID™, WEBOS® or RIM®. The web server 150 may also provide data to one or more advertiser systems 104.

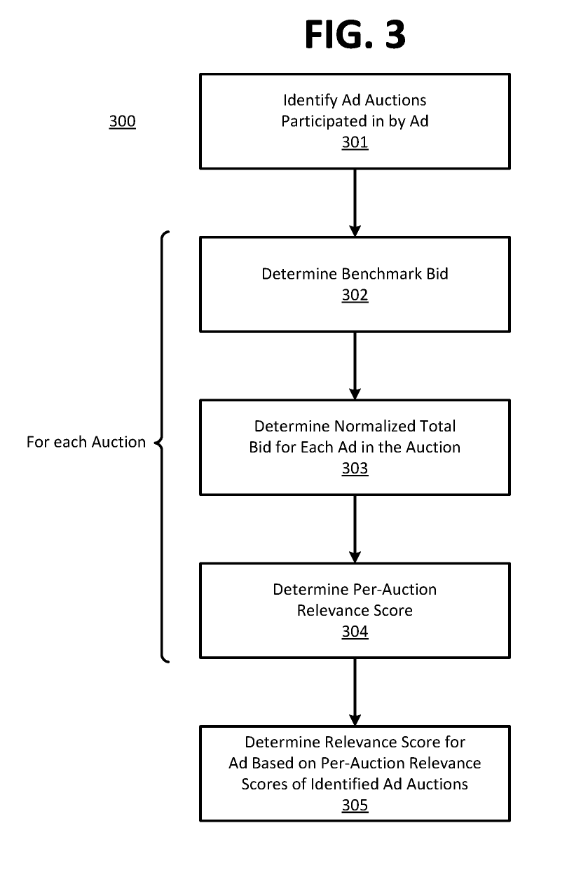

The relevance score module 190 computes a relevance score for an ad 131, which is a metric indicative of the effectiveness of the ad 131 based on user interactions with the ad 131. The relevance score module 190 can compute the relevance score based on the user interactions with the ad 131 stored in the ad interaction store 140. The relevance score can be computed by comparing the interactions of an ad 131 to the interactions of other similar ads. A similar ad may be an ad with similar ad content, a similar ad type, a similar target group, and/or a similar bid goal. The relevance score quantifies the effect of the content of an ad 131 on user engagement. The relevance score may be computed periodically and stored in association with an ad or transmitted to an advertiser system 104. Alternately, the relevance score module 190 may compute a relevance score responsive to a request from an advertiser system 104, such as a request through an API or a request for a web page which displays the relevance score. In some embodiments, the social networking system 110 only generates a relevance score for an ad 131 once a certain number of user impressions for the ad have been logged in the user interaction store 140. For example, a social networking system 110 might present an ad 131 to five hundred users before generating a relevance score for the ad 131. The computation of the relevance score by the relevance score module 190 and presentation of the relevance score to an advertiser is further described below in conjunction with FIG. 3.

### Social Network User Interface

FIG. 2A and FIG. 2B illustrate a user interface 200, according to an embodiment. The web server 150 of the social networking system 110 serves data, such as a web page, to a user device 102 which allow the user device 102 to display the user interface 200. The web server 150 may serve different user interfaces to different user devices 102 responsive to the type of user device 102 requesting the data. For example, a mobile device accessing the social networking system 110 via a dedicated software application, a mobile device accessing the social networking system 110 via a web browser, and a personal computer accessing the social networking system 110 via a web browser might each be presented with a different user interface. The type of ads, as specified by the ad content 132, presented on each type of device may be different, as well. For example, some ads are only presented to mobile devices and other ads are presented to all devices.

The user interface 200 may include a newsfeed 201, which contains user-generated content accessed from the content store 160, such as user post 202. The user post 202 may be a content item created or uploaded by another user who the user viewing the user interface 201 is connected to on the social networking service 110 (e.g., a “friend” of the user). The user post 202 may be, for example, a status, a digital image, a gallery of digital images, or a text post. The user interface 200 may provide means for interacting with and providing feedback to the user post 202.

The newsfeed 201 may also contain advertisements such as the sponsored post 210. The sponsored post 210 contains an ad title 211, an ad subtext 212, an ad image 213, and an ad icon 214. The ad title 211, the ad subtext 212, the ad image 213, and the ad icon are examples of ad content which is stored in the ad store 130. The sponsored post 210 also displays a text object 215 that reads “User 1, User 2, and 5 others like ‘Advertiser’.” In practice, “User 1” and “User 2” is typically replaced by the names of users (e.g., friends of the user) to whom the user that is viewing the user interface 200 is connected to via the social networking system 110. Likewise, “Advertiser” would be replaced by the name of a page on the social networking service 110 associated with the advertiser.

Responsive to the user clicking on the sponsored post 210, the user can be routed to a resource indicated by a network address that is part of the ad content of the sponsored post 210. The resource can be a web page or a page on the social networking system 110. Such an interaction is denoted herein as a “click.” Other analogous types of user interaction are also considered a “click” even if the interaction does not, strictly speaking, involve a mouse click (e.g., a user tapping on a touch screen).

The sponsored post 210 also contains user interface elements for a user to socially interact with the advertisement without proceeding to the resource linked to the ad content. These interactions may increase or decrease the user's engagement with the advertisement, such as by publically associating the viewing user with the page or by indicating that the advertisement is not of interest to the user. For example, such user interface elements may include a “like page” button 216. Pressing the “like page” button 216 is referred to as “liking” the page (e.g., a page on the social networking service 110) and an instance of a user interacting with this button is referred to as a “like.” The page of the social networking service 110 which is “liked” may be the page which is indicated by the network address of the ad content. Other means of “liking” an ad can include interacting with a similar “like” button on a social network page associated with the advertiser or a web page outside of the social networking system 110.

When the sponsored post 210 is presented to a user, the sponsored post 210 can indicate that other users of the social networking system 110 who are connected to the user (e.g., friends of the user) to which the ad is being displayed have “liked” the ad (e.g., in the example illustrated in FIG. 2A, the users who are connected to the user to which the ad is being displayed who have liked the ad are “User 1” and User 2”, as well as 5 other users). Pressing the like page button 216 or otherwise “liking” a page therefore permits the advertisement to be displayed to other users of the social networking system with an indication that the user likes the advertisement, the advertiser associated with the advertisement, or a page associated with the advertiser. “Liking” a page is a social signal that constitutes a type of user feedback and can be considered to be a positive indicator of an ad's effectiveness. As further described below, pressing the “like page” button 216 the page may increase the relevance score of the sponsored post 210. In some embodiments, a sponsored post includes a button for “liking” an ad itself, in addition to or as an alternative to a link to the page associated with the advertiser. In addition to the “like” button, additional social user interactions with the sponsored post may include commenting on the ad content, sharing the ad content, or saving the ad content.

The ad content of the sponsored post 210 also contains a dropdown menu button 217 which allows the user to provide additional feedback about the sponsored post 210. Clicking on or tapping the dropdown menu button 217 opens up the dropdown menu 230, as shown in FIG. 2B. In this embodiment, the dropdown menu 230 contains five buttons. The buttons are labeled “I don't want to see this” 231, “Hide all ads from this Advertiser” 232, “Save ‘Advertiser’” 233, “Why am I seeing this?” 234, and “this ad is useful” 235. Clicking on or tapping these buttons may affect which ads are presented to the user in future impressions. These buttons in the dropdown menu 230 provide additional user interaction with the sponsored post 210. Clicking or tapping on the “I don't want to see this” 231 and the “Hide all ads from this Advertiser” 232 buttons may be considered negative feedback, which may decrease the relevance score of the sponsored post 210. On the other hand, the “Save ‘Advertiser’” 233 and “This ad is useful” 233 buttons can be considered positive feedback, which may increase the relevance score of the sponsored post 210.

Another type of ad is illustrated by ads 220 and 225. Ads 220 and 225 appear outside the newsfeed 201 and may provide similar interactions for a user, though they are shown in this embodiment has having a reduced set of interactions relative to sponsored post 210. The ad content of each of each ad includes respective ad images 221 and 226, ad titles 222 and 227, and ad subtexts 223 and 228. Because, the ads 220 and 225 are of a different ad type than the sponsored post 210, they include different kinds of content (e.g. the ad images 221 and 226 are smaller than the ad image 213 of the sponsored post 210 and the subtext 223 contains fewer maximum characters than the subtext 212). The ads 221 and 225 are also presented with an “x-out” buttons 224 and 229, which, when clicked or tapped by the user, will stop the respective ad from being displayed, and can, in some embodiments, prevent the same ad from being displayed to the same user in the future. The “x-out” buttons 224 and 229 can be considered negative feedback, which may decrease the relevance score of the respective ad as further described below. This type of user interaction with an ad is denoted herein as an “x-out.” Like the sponsored post 210, ads 221 and 226 may also receive “clicks,” which can likewise be considered positive feedback to the ad. In addition to sponsored posts 210 and ads 220 and 225, many other types of ads can be presented to the user via the user interface, such as video ads, ads with different form factors, text-only ads, and animated ads.

After ads 221, 226 or the sponsored post 210 is presented to a user, the social networking system 110 may store the user's interaction with each ad as a user interaction in the ad interaction store 180 in association with user profile (e.g., 121) of the user and the ad (e.g., 131). The stored user interaction may include user interaction parameters indicative of the user's interaction with the ad and feedback provided by the user to the ad. The user interaction may include some combination of user interaction parameters for a “click,” a “like,” an “x-out”, a press of a button on the dropdown menu 230, or other social signals. The stored user interaction may also indicate what the bid goal of the ad was. The user interaction may further include information indicating how the ad was displayed to the user (e.g., whether it was displayed in the newsfeed 201).

### Bidding Structure

In embodiments that allocate ad space among ads via a bidding structure, an ad 131 has a corresponding bid 135. The ad auction module 170 performs an auction to determine a winning ad and a winning bid to be paid by the associated advertiser. The advertiser may pay for the advertisement based on each impression of the advertisement (i.e., each time the advertisement wins the auction and is displayed), or based on a “per action” basis, the action being a specific form of user interaction indicated by the advertiser. In general, the action includes a user interacting with the advertisement to reach a page referenced by the advertisement, and may further include additional actions related to the advertiser, such as interacting with the referenced page or purchasing a product from the advertiser. The action may be the interaction with the advertisement alone (“per-click”) or with a further interaction with the advertisement (“a conversion”). Thus, the expectation value for the payout received from the advertiser for each ad displayed is expressed by the following equation:

E[payout]=B*Pr(click)*Pr(action|click)

B is the bid of the advertiser. In some embodiments, an advertiser specifies a maximum bid for an advertisement. Pr(click) is the probability that a user will click on an ad when the ad is presented and Pr(action|click) is the probability that the user performs an action given that the user has clicked on the ad (i.e., a Bayesian conditional probability). If the action is the click itself (“per-click”), then Pr(action|click)=1. If the bid is based on a per impression basis, then Pr(click) and Pr(action|click) need not be considered, because the payout is deterministic and is simply equal to E [payout]=B. Since the advertisements typically compete for users by competing for individual impressions of the advertisements, a value denoted as eCPI (estimated cost per impression) may be calculated for individual advertisements to compete on a per-placement basis. In this case, eCPI may be is calculated as:

eCPI=B*eCTR*eCVR

eCTR is the estimated click through rate, which is an approximation of Pr(click). eCVR is the estimated conversion rate, which is an approximation of Pr(action|click). As with Pr(action|click), if the action is itself a click, then eCVR does not need to be calculated and is equal to eCVR=Pr(action|click)=1. If the bid 135 is based on a per impression basis, then eCPI does not need to be calculated and is equal to eCPI=B. eCTR and eCVR can be calculated by looking at the user interaction store 180. In one embodiment, eCTR=(number of times the ad was clicked)/(number of times the ad was displayed) and eCVR=(number of times the bid action is performed)/(number of times the ad was clicked on).

In some embodiments, the social networking system 110 can calculate the eCPI for every ad of a specific type that contain a user in the ad's target group. An auction is held to select an advertisement, which typically results in the ad with the highest eCPI selected for the user. The bid, B, is used to calculate the eCPI for each ad and may be the maximum bid of the ad in a second-price or Vickrey auction, though other auction types may also be used.

In some embodiments, the social networking system 110 also uses an “organic score” (represented herein as θ) along with the eCPI to decide which ad to display to a user. This organic score θ is based on user interaction data, such as the number of “x-outs,” “likes,” comments, and “clicks,” among other things to modify a bid prior to use in the auction. The inclusion of this organic score θ promotes high quality ad content and discourages low quality advertisements based on user engagement with the advertisements that may be independent from actions that lead directly to payment via the auction. The organic score may combine one or more signals from the user interactions described above to determine user preference for the advertisement. One method for calculating the organic score θ uses a linear combination of estimated rates for the various user signals. E.g.,

θ=w_{click}*eCTR+wₗᵢₖₑ*eLR+wₛₕₐᵣₑ*eSR−w_{neg}*eNFB

w_{click}, wₗᵢₖₑ, wₛₕₐᵣₑ, and w_{neg} are weights (i.e. scalars). w_{click}, wₗᵢₖₑ, wₛₕₐᵣₑ, and w_{neg} are greater than or equal to 0. The eLR and the eSR are the estimated like and share rates, respectively. In one embodiment, eLR and eSR are based on the user interaction store 180 of an ad 131 and eLR=(number of users to “like” the ad)/(number of times the ad was displayed) and eSR=(number of users to share the ad)/(number of times the ad was displayed). In general a user “likes” an ad by pressing a “like” button on the ad itself, on a web page associated with the ad, or on the social network page of the advertiser. Similarly, a user can “share” an ad by pressing a “share” button, which will instruct the social networking system 110 to display the ad to a set of users which the first user is connected to via the social networking system 110. The eNFBR is the negative feedback rate. Negative feedback can take the form of an “x-out”, a user pressing a “do not show this ad anymore” button, or some other type of negative feedback. In one embodiment, eNFBR=(number of users to provide negative feedback to an ad)/(number of times the ad was displayed). Different types of negative feedback may we weighed differently. Negative feedback will decrease the organic score. w_{click}, wₗᵢₖₑ, wₛₕₐᵣₑ, and w_{neg} may be static constants or may be generated based on the rates of the various signals in the social networking system 110, in a specific group, or for a specific user.

A linear combination is only one of many ways to calculate the organic score, θ. Alternate embodiments can use some other function of eCTR, eLR, eSR, and eNFBR to calculate the organic score. Usually, these functions will be monotonically increasing for eCTR, eLR, and eSR and monotonically decreasing for eNFBR. Other embodiments incorporate additional user interaction parameters or omit at least one of eCTR, eLR, eSR, and eNFBR as parameters for a function to generate the organic score. In some embodiments, eNFBR is split into multiple parameters which each measure the rates of different types of negative feedback. Additionally, the positive interactions of a user with the advertisement may be combined into an ePFBR indicating positive user interactions with the advertisement, and may account for a variety of different types of feedback a user may provide to the advertisement. In some embodiments, actions that are related to payment by the advertiser (i.e., those actions linked to the bid or that lead to the bid-action, such as a click-through) are excluded from the organic score, as those may be accounted for in the eCPI. In some embodiments, the stored user interactions used to generate eCPI and θ for an ad may be selected from a subset of the total user interactions of the ad. In some embodiments, the subset of user interactions includes only user interactions from recent impressions. In some embodiments, when a bid is being calculated to present ads to a user the subset of user interactions used to calculate the eCPI and θ for the bidding ads only includes user interactions presented to users similar to that user.

The organic score and eCPI can be combined to generate a total bid, B_{T}. In one embodiment, B_{T}=eCPI+θ. The total bid, B_{T}, can be calculated for each ad which has a target group that includes a particular user. The ad with the highest total score may then be presented to the user. In some embodiments, each ad has a single eCPI and θ. In some embodiments, eCTR, eLR, eSR, and eNFBR are calculated by taking an average of a subset of user interactions. For example, users can be partitioned into groups, where the groups are portioned according to user characteristics, and an ad can have an eCPI and organic score, θ, for each group in the ad's target group. When an ad competes in an auction to display an ad to a user in a certain group, the total score can be calculated using values of eCPI and θ specific to that group.

The estimated cost per impression, eCPI, and the organic score, θ, can be normalized so that that each constitutes a set percentage of the total score, on average. E.g., the eCPI and the organic score can be normalized for a group of users so that, on average, eCPI constitutes 80% of a total score and organic score constitutes 20%. The eCPI and the organic score can also be normalized so that each constitutes a certain percentage of the highest bid score, on average. In embodiments where an ad's bid is a maximum bid, the actual bid paid by the advertiser can be equal to the bid required for the highest score to equal the second highest total score. E.g., if B₁ is the bid that the winning advertiser pays and B₂ is the maximum bid of the second advertiser, then B₁=(B₂*eCTR₂*eCVR₂+θ₂−θ₁)/(eCTR₁*eCVR₁).

### Relevance Score

FIG. 3 is a block diagram illustrating a method for calculating a relevance score for an ad, denoted herein as the first ad, A₁. This method 300 may be performed, for example by the relevance score module 190 and is one way for determining a relevance score. The relevance score is a metric indicative of the quality of A₁ in comparison to other ads competing in auctions for users in the target audience of A₁. The relevance score is calculated so that the comparison of the ads can be based on user interaction with the ads rather than dominated by the advertiser-specified bids of the ads. That is, the relevance score indicates whether user interactions with an ad compare favorably or unfavorably to user interactions with other ads. Unlike the total bid calculated during an auction, the relevance score is not based on the advertiser-specified bid (e.g., bid 135).

The method 300 identifies 301 ad auctions that the ad, A₁, participated in. The identified auctions may be a subset of the auctions that the ad participated in (e.g., the N most recent auctions or all auctions within a threshold period of time). Each ad auction may be stored in auction store 175. The relevance score module 190 may determine 304 a per-auction relevance score for each auction and combine the per-auction relevance scores into a single relevance score for the ad.

In some embodiments, the relevance score for an ad is based on a subset of the ad's user interactions corresponding to ad auctions for users in a test target group. For an ad with a target group, the social networking system 110 can create a test target group and generate a test relevance score for that test target group. The test target group can be a subgroup of the target group for the ad. In some embodiments, the test target group is generated by correlating user characteristics with the performance of an ad. For example, the social networking system 110 may calculate the correlation between the ages of users with the performance of an ad. If there is a strong positive or negative correlation, a test target group may be formed which contain only older or younger members of the original target group. In some embodiments, the advertiser selects user characteristics to specify a test target group and create a corresponding test relevance score. The relevance score module 190 may calculate a test relevance score with a test target group by identifying 301 a subset of the ad's ad auctions that corresponds to users in the target group. The relevance score module 190 may also calculate a relevance score with the actual target group by identifying 301 ad auctions selected from the ad auctions for the ad. By comparing the test relevance score to the actual relevance score for the entire target group of the ad, the social networking system 110 may display to an advertiser whether the test target group performs better or worse than the target group.

Similarly, the text content of an ad can be parsed and a test target group can be created and tested based on the text content of the ad. For example, when the social networking system 110 identifies that an ad contains the word “sweaters,” the social networking system 110 can generate a test target group that have “liked” clothing related pages. The images or videos of the ad can also be analyzed using a machine vision system to determine objects that are in the image or video, and test target groups can be constructed to contain users that have “liked” pages relating to the objects identified by the machine vision system. In some embodiments, the social networking system 110 identifies correlations between user details and the content of ads which receive positive feedback. If the social networking system 110 identifies a positive correlation between the amount of positive feedback that an ad that features a certain type of content receives and a certain user characteristic, then the social networking system 110 can create test target groups for ads that have that type of content, where the test groups include users with the given user characteristic.

If the test relevance score calculated for the test target group is sufficiently higher than the relevance score of the original target group, a suggestion can be displayed to the advertiser to change the target group of the ad to the test target group. Similarly, if the test relevance score is sufficiently lower than the relevance score of the original target group, a suggestion can be displayed to the advertiser to remove the test target group from the target group of the ad. The relevance score for the original target group and the test target group's relevance score can be displayed along with the suggestion to change the target group of the ad.

After ad auctions are identified 301, a per-auction relevance score for the ad A₁ is determined for each ad auction. As more fully discussed below, the per-auction relevance score for the ad A₁ is determined relative to the set of ads that participated in the ad auction. The set of N ads that competed in a stored ad auction is denoted herein as {A₁, . . . , A_{N}}. For the set of ads in an auction, a benchmark bid is determined to account for varying bids by the different advertisers (denoted herein as B_{bm}). A normalized total bid may be determined 303 for each ad {A₁, . . . , A_{N}} based on the benchmark bid B_{bm}. The normalized total bid for each ad accounts for the benchmark bid of the auction and incorporates the organic bids associated with each ad to account for the individual conversion and interaction information for the ads without varying advertiser bids. The set of normalized total bids (denoted herein as {R₁, . . . , R_{N}}) is used to generated a per-auction relevance score for the ad A₁. This per-auction relevance score is combined with the per-auction relevance scores for other auctions in which the ad, A₁, participated to determine 305 a single relevance score for the ad A₁ across the identified ad auctions. Each of these steps is now described in further detail.

For each auction, a benchmark bid B_{bm} is determined 302. The benchmark bid B_{bm} is analogous to the advertiser defined bid (e.g., 135) used during an ad auction, and reflects a standard bid amount used across more than one advertiser for an auction. However, the benchmark bid B_{bm} is not specified by the advertiser. The benchmark bid B_{bm} may be the mean bid for all ads in the auction (e.g., the mean maximum bid for each ad in {A₁, . . . , A_{N}}). The benchmark bid B_{bm} may also be the median bid of all ads in the auction. The benchmark bid B_{bm} may also be the winning bid in the auction, the second place bid in the auction, or the bid paid by the winning ad. The benchmark bid B_{bm} may also be a value used across all auctions for a specific ad type, user interface ad location, bid goal or some combination thereof. The benchmark bid B_{bm} may also be the advertiser specified bid of the ad A₁. The benchmark bid B_{bm} may be the same for each ad {A₁, . . . , A_{N}} in the auction. By using the same benchmark bid B_{b72} to calculate a normalized total bid for all ads in the auction, the relevance score can mitigate the effect of advertiser specified bids on the normalized total bid.

In an alternate embodiment, different benchmark bids are used within an auction. The benchmark bid may be the same for all ads in the auction of the same ad type (e.g., video ads as opposed to image ads) or for all ads which display in the same user interface location (e.g., ads that are displayed in a newsfeed as opposed to ads that are displayed outside the newsfeed). Alternately the benchmark bid may be the same for all ads with the same bid goal (e.g., pay per click as opposed to pay per impression).

For each ad Aᵢ in the auction, a normalized total bid Rᵢ is determined 303 using the benchmark bid B_{bm}. Like the benchmark bid B_{bm}, the normalized total bid is not a bid per se, but is roughly analogous to the total bid calculated when advertisers are bidding for an advertising opportunity, as discussed above. However, the normalized total bid is not a function of the advertiser specified bid (e.g., 135). The use of the benchmark bid B_{bm} instead of the advertiser specified bid results in a normalized total bid for each ad that is a function of user interaction with the ad. Unlike the total bids used in the ad auction to select an ad for display, the normalized total bids are used for comparison of ads to determine 304 a per-auction relevance score for the ad.

In one embodiment, the normalized total bid for an ad Aᵢ is calculated as Rᵢ=(eCTR)ᵢ*(eCVR)ᵢ*B_{bm}+θᵢ. B_{bm} and θᵢ, respectively, are the benchmark bid and the organic score of the ad Aᵢ. (eCTR)ᵢ and (eCVR)ᵢ are the estimated click through rate and the estimated conversion rate, respectively. In this example, the benchmark bid is calculated relative to a conversion. Thus, the product of (eCTR)ᵢ and (eCVR)ᵢ (i.e., (eCTR)ᵢ*(eCVR)ᵢ) is an estimation of the rate at which the bid goal of the ad Aᵢ is performed when Aᵢ is displayed. The values of (eCTR)ᵢ, θᵢ, and (eCVR)ᵢ for an ad Aᵢ may be stored in the auction store 175 at the time that the auction is performed.

A per-auction relevance score RS for the ad A₁ is determined 304 for the auction based on a comparison of the ad's normalized total bid R₁ to the set of normalized total bids for the other ads {R₂, . . . , R_{N}} in the auction. The per-auction relevance score is indicative of the relative quality of the ad in comparison to competing ads in a specific auction. The per-auction relevance scores of the various auctions are combined to determine 305 the relevance score. The relevance score RS of A₁ may be based on the position of A₁'s normalized total bid R₁ in the distribution of normalized total bids {R₁, . . . , R_{N}} for competing ads. By comparing the normalized total bids in this way, the relevance score module 190 may quantify the user feedback for the ad A₁ in comparison to that of the competing ads {A₂, . . . , A_{N}}. In one embodiment, the per-auction relevance score RS is scaled for each auction based on a score or a range of scores. In one example, the per-auction relevance score is determined by RS=a*(R₁−Rₘᵢₙ)/(Rₘₐₓ−Rₘᵢₙ) where Rₘₐₓ and Rₘᵢₙ are the respective maximum and minimum values found in the set of normalized total bids {R₁, . . . , R_{N}} and a is a constant (e.g., a=10). Thus, the per-auction relevance score RS is a value between 0 and a.

In some embodiments, the per-auction relevance score RS is based on a sample mean μ and a sample variance α² calculated for the set of normalized total bids {R₁, . . . , R_{N}}. In some embodiments, mean and variance are calculated from the set of all ad auctions, or may be determined for individual auctions. In another embodiment, the normalized total bids, {R₁, . . . , R_{N}}, are sorted into an ordered list, wherein the normalized total bids are ordered from highest to lowest. The per-auction relevance score of each ad may be proportional to its position in the list. That is, the per-auction relevance score RS for A₁ may be proportional to the position of R₁ in the list. For example, if p is the position of R₁ in the ordered list of normalized total bids, then RS=a*(p−1)/(N−1) where a is a constant (e.g. if a=10 and RS=7.5 then the ad, A₁ has a normalized total bid R₁ that is better than 75% of the other ads in the auction).

The relevance score for the ad A₁ is determined 305 from the per-auction relevance scores of the identified auctions. The relevance score may be the mean or the median per-auction relevance score.

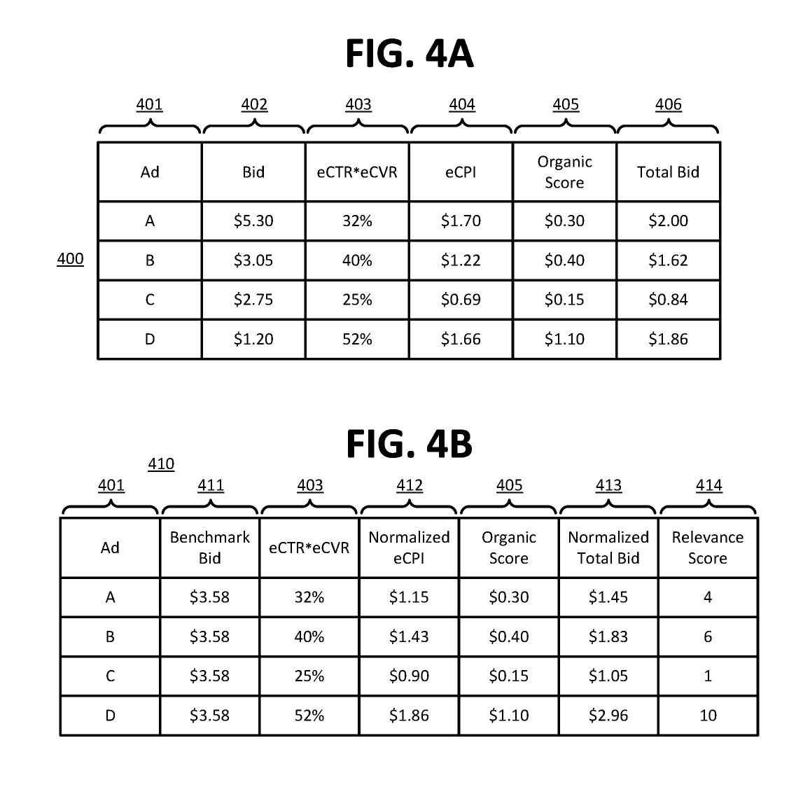

FIGS. 4A and 4B illustrate tables of values calculated for a single ad auction, in accordance with an embodiment. In some embodiments, the values in auction tables 400 and 410 are stored in the auction store 175. The auction table 400 of FIG. 4A includes an ad column 401, a bid column 402, a bid goal rate column 403, an eCPI 404 column, an organic score column 405, and a total bid column 406. By processing an ad auction, the social networking system 110 selects an ad to display to a user. The ad auction may specify user characteristics about the user and an ad type for the ad. The tables shown in FIGS. 4A and 4B are provided for illustrating the auction and relevance score determinations, and in various embodiments may not be separately computed by the relevance score module 190.

The ad column 401 contains an identifier for each ad competing in the auction for an impression. In this example, the auction table 400 includes 4 ads: A, B, C, and D. The identifier for each ad may be a reference to an ad stored in the ad store 130. The entry in each row of the auction table corresponds to the ad in the ad column 401 of that row.

The bid column 402 contains the bid of each ad for the auction. The bid may be the maximum bid specified by the advertiser associated with the ad. The bid may be associated with a bid goal, as discussed above. The bid goal rate column 403 includes an estimate of the rate which an ad's bid goal is performed by a user presented with the ad. In general, the bid goal rate is calculated as the product of eCTR (estimated click through rate) and eCVR (estimated conversion rate). The eCPI column 404 contains the calculated eCPI (estimated cost per click) for each ad. The eCPI is the estimated payout to the social networking system 110 for displaying the ad, assuming the maximum bid is used. The eCPI is generally calculated as the product of the estimated bid goal rate and the advertiser bid.

The organic score column 405 contains the organic score for each ad. The total bid column 406 contains the total bid for the auction. The total bid is a combination of the organic score and the eCPI. The total bid may be the arithmetic sum of the eCPI and the organic score. When the auction was held, these total bids were used to compete in the auction, and the highest total bid is selected for presentation to the user. If the user performs the bid goal of the winning ad, the advertiser associated with the winning ad may pay the social networking system an amount based on the auction results.

FIG. 4B illustrates a table of values calculated to generate per-auction relevance scores for ads that bid in an auction, in accordance with an embodiment. The per-auction relevance score table 410 includes an ad column 401, a benchmark bid column 411, a bid goal rate column 403, a normalized eCPI column 412, an organic score column 405, a normalized total bid column 413, and a relevance score column 414. The values in the per-auction relevance score table 410 may be stored in the auction store 175 of the social networking system 110. The per-auction relevance score table 410 corresponds to the same auction as the auction table 400 depicted in FIG. 4A.

The benchmark bid column 411 contains the benchmark bid for the auction. In the per-auction relevance score table 410, each ad has the same bid goal, so the benchmark bid for each ad is the same. Each entry in the normalized eCPI column 412 is the product of the benchmark bid and the bid goal rate. In other examples, the bid goals for each advertiser may differ, in which the bid goals may account for the different bid goal frequency to adjust the benchmark bid upwards or downwards to account for the increased or decreased goal frequency. The normalized total bid column 413 contains the normalized total bid for each ad. The normalized total bids are analogous to the total bids of the total bid column 416 except that they are based on the benchmark bid rather than the advertiser specified bids. The normalized total bid for an ad may be the sum of the normalized eCPI and the organic score.

The relevance score column 414 contains the per-auction relevance score for each ad. The set of per-auction relevance scores are calculated based on the set of normalized total bids. The per-auction relevance score of an ad (e.g., ad A) is indicative of the normalized total bid of the ad compared to the normalized total bids of all other ads (e.g., ads B, C, and D). In this example, because ad D has a normalized total bid higher than the normalized total bids of the other ads, ad D has a high per-auction relevance score. This in contrast to the total bid of ad D in the auction table 400, which was not the highest because of ad D's relatively low advertiser specified bid. Similarly, ad C has a low per-auction relevance score because its normalized total bid is relatively low.

The per-auction relevance scores for each ad in an auction may be computed by the relevance score module 190 and stored in the auction store 175. The relevance score of an ad may be calculated by identifying the relevant impressions and accessing the stored per-auction relevance scores.

As described above, the relevance score for an advertisement, such as advertisement B, may be determined by combining the per-auction relevance scores, such as shown in table 410. This combination may be the average, such as a mean or median, of the per-auction relevance scores.

### Providing Ad Feedback to an Advertiser

The relevance score of an ad can be present to the advertiser associated with the ad along with other data metrics for the ad. The relevance score can be calculated periodically or can be calculated responsive to a request from the advertiser. If a plurality of ads are associated with a single advertiser, then the relevance score of each ad can be displayed to an advertiser in a single user interface, so that an advertiser can easily compare the effectiveness of various ads. Factors that are used to calculate the relevance score can also be displayed to the advertiser along with the relevance score.

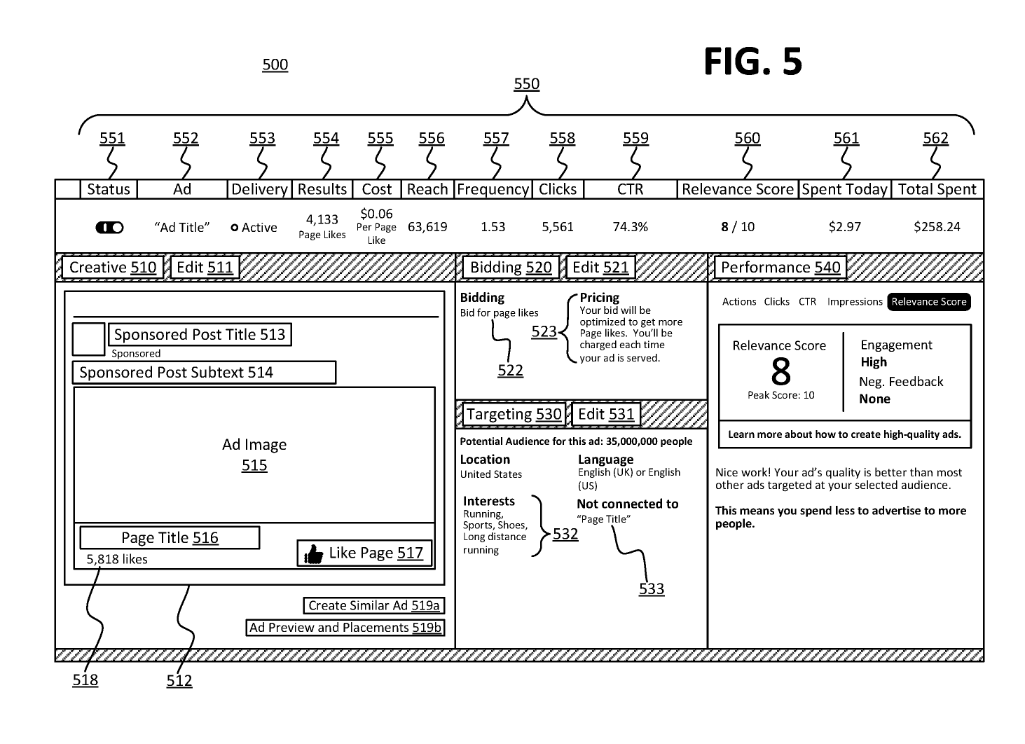

FIG. 5 illustrates an advertiser user interface 500 which displays ad performance metrics to an advertiser system 104, in accordance with an embodiment. The advertiser user interface 500 may be part of a web page or a page on a mobile application. The web server 150 of the social networking system 110 provides information sufficient to display the advertiser user interface 500 on a display of the advertiser system 104 via the network 106. The advertiser user interface 500 includes a creative panel 510, a bidding panel 520, a targeting panel 530, a performance panel 540, and an ad metrics panel 550.

The advertiser user interface 500 displays information relating to a specific ad. In FIG. 5, the ad is a sponsored post 512, which is displayed in a creative panel 510. The creative panel 510 displays the content of the sponsored post 513 to provide a preview of what the sponsored post 513 looks like when displayed to a user. The sponsored post 512 includes a sponsored post title 513, a sponsored post subtext 514, an ad image 515, a page title 516, a “like page” button 517, and a “like” counter 518. The sponsored post title 513, a sponsored post subtext 514, and an ad image 515 are specified by the advertiser. The page title 516 is the title of a page associated with the advertiser on the social networking service 110. When the advertiser is presented to a user, the “like page” button 517 will register a “like” of the page identified by the page title 516. Such a user interaction is a type of social signal. The “like” counter 518 displays the total number of “likes” that the page has accumulated. In the embodiment illustrated in FIG. 5, the page has accumulated 5,818 “likes” from user profiles of the social networking system 110.

The creative panel 510 also includes an edit button 511 which may allow the advertiser to edit the content of the sponsored post 512. The creative panel 510 also includes a “create similar ad” button 519a which allows the advertiser to create a new advertisement using the sponsored post 512 as a template. Finally, the creative panel 510 includes an “ad preview and placements” button 519b, which allows the advertiser to preview the sponsored post 512 in a manner indicative of the way that the sponsored post 512 is displayed to users. For example, the sponsored post 512 is displayed in a newsfeed similar to the newsfeed 201 in the user interface 200.

The advertiser user interface 500 includes a bidding panel 520. The bidding panel 520 displays the bid type of the sponsored post 512. The bid type of the sponsored post 522 is a based on page “likes.” Thus, the advertiser system 104 pays the social networking system 110 whenever a user to whom the ad is presented “likes” the page associated with the sponsored post 512. A “like” which triggers advertiser system 104 to pay the social networking system 110 may be initiated by a user pressing the “like page” button 517. A user who presses on the sponsored post 512 is then routed to the page of the advertiser. The user may then like the page via a button, similar to the “like page” button 517 on the page. Such an event may also be considered a payment-triggering “like.” In some embodiments, a user who “likes” a page within a time frame of being presented with the sponsored post 512 without ever interacting with the sponsored post 512 or clicking the “like page” button 517 on the sponsored post 512 may also be considered a payment-triggering “like.” The bidding panel 520 also includes a pricing description 523 which includes a short description describing how the advertiser is charged for the advertisement. The bidding panel 520 also includes an edit button 521 which allows the advertiser to change the bidding and pricing structure of the sponsored post 512.

The advertiser user interface 500 includes a targeting panel 530. The targeting panel 530 displays user characteristics which specify the target group of the sponsored post 512. The targeting panel 530 displays the location and language to which the target group of the ad is restricted. Specifically, the advertiser has specified that the sponsored post 512 be displayed to users in the United States who have the language setting of either “English (UK)” or “English (US).” The targeting panel 530 also displays a list of interests 532 which define the target group. Users in the target group may be required to have at least one of the interests in the list interests 532. The interests of the target group listed in FIG. 5 are “running,” “sports,” “shoes,” and “long distance running.” This list of interests 532 may be suitable for advertisements relating to, for example, running shoes or sportswear. A user may be determined to have interest in a topic based on information explicitly shared by the user or information inferred by the social networking system 110. A user's interests may be determined by past interaction with other ads. The targeting panel 530 also displays a “not connected to” restriction 533, which limits the target group to users who are not already connected to the page of the social network 110 denoted by “Page Title.” A user can be considered connected to a page if the user has already “liked” the page. In this manner, the advertiser can avoid soliciting page “likes” from a user who has already liked the page. The targeting panel 530 also displays an estimate of the number of users of the social networking system 110 who are in the target group (34,000,000 users). The edit button 531 allows the advertiser to edit the user characteristics which define the target group of the ad.

The advertiser user interface 500 also includes a performance panel 540. The performance panel 540 displays metrics derived from logged user interaction with the sponsored post 512. In FIG. 5, the relevance score has been selected for display, and consequently, the relevance score of the sponsored post 512 is displayed in the performance panel 540. The relevance score of the sponsored post 512 is 8 out of a maximum score of 10. The relevance score compares logged user engagement for the sponsored post 512 to that of other ads with the same or similar target groups. The performance panel 540 also displays a description of user engagement with the ad (“high”) and negative feedback received for the ad (“none”) along with a text description to explain the relevance score.

The ad metrics panel 550 displays twelve metrics regarding the sponsored post 512. The metrics displayed on the ad metrics panel 550 are status 551551, ad title 552, delivery 553, results 554, cost 555, reach 556, frequency 557, clicks 558, CTR 559, relevance score 560, spent today 561, and total spent 562. The status 551 displays an indicator of whether the ad is currently set to be displayed or not. The advertiser can interact with the indicator to suspend or start display of the ad. The ad title is 552 is a title which the advertiser can use to distinguish between ads. The delivery 553 displays whether the sponsored post 512 is currently competing in bids to be displayed to users. The results 554 display the outcome of displaying the sponsored post 512 to users. The results 554 are specific to the bid goal of the advertisement. Thus, because the sponsored post 512 has a bid goal of page “likes” the results 554 displays the number of users who have “liked” the page of the advertiser as a result of being presented with the sponsored post 512. The cost 555 displays the cost to the advertiser per bid goal (e.g., dollars per page “like”). The reach 556 displays the total number of users to whom the sponsored post 512 has been presented or the total number of times the sponsored post 512 has been displayed to any user. The frequency 557 displays the average number times that users who have view the ad at least once have viewed the ad. The clicks 558 show the total number of “clicks” that the ad has generated. The CTR 559 displays the click through rate (i.e. the number of “clicks” divided by the number of impressions). The relevance score 560 displays a score indicative of the performance of the ad relative to other ads on the social networking service 110 with the same or similar target group. Spent today 561 and total spent 562 display the cost to the advertiser for that day and in total, respectively.

Thus the advertiser user interface 500 provides a means for the advertiser to view and edit the properties of an ad stored in an ad store 130 of a social networking system 110, such as the ad's content, the target group, and the bid. The advertiser user interface 500 also displays information to the advertiser indicative of the results of the ad and user engagement with the ad. The relevance score is a metric indicative of the effectiveness of the ad as measured by user feedback relative to that of other ads that target similar users. The user engagement statistics displayed to the advertiser in the performance pane 540 and the ad metrics panel 550 may assist the advertiser in understanding the relevance score and thus the performance of the ad.

### Predicting Relevance Scores

In some embodiments, the social networking system 110 estimates a predicted relevance score for the target group of an ad prior to presenting the ad to any users. This predicted relevance score is based on the content of the ad. The text content of the ad, such as the ad's title and subtext, may be parsed and compared to the historical performance of other ads which contain similar words or grammatical structures. Similarly, images in an ad can be analyzed with a machine vision system which can identify objects in the image. The presence of objects in an ad can be used to provide a predicted relevance score based on past user interaction with ads containing similar objects. The appearance of objects in an ad can also be factored into the predicted relevance score. For example, if a facial recognition system identifies that an ad contains a close-up image of a person's face then ads which similarly contained close-up images of people's faces can be weighed more heavily when generating the predicted relevance score than ads which just contained an image of a person's face. Image characteristics, such as the brightness, hue balance, contrast, or high/low frequency content can be used to compare an ad with previous ads in order to generate a predicted relevance score. Parsing the text content or analyzing images or video of the ad may include determining an item, set of items, or service that is being advertised. In some embodiments, an advertiser can indicate the item or service which is being advertised without displaying that indication.

In an example embodiment, the social networking system 110 parses the text content of an ad, A, to identify a set of text keywords and analyzes an image or video in the ad to identify a set of objects and image characteristics. Herein, {C₁, . . . , C_{N}}, denotes the combined set of text keywords, identified image objects, and image characteristics of the ad A. The system identifies a set of similar ads, {a₁, . . . , a_{M}} which have at least one of the ad characteristics and which are considered relevant based on the ad's target groups. Next, a set of weights, {w₁, w_{M}}, are generated for each of the ads. In one embodiment, the weight of an ad is based on the ad characteristics which the ad shares with the ad, A. Ads that share ad characteristics with A that are more predictive of the relevance score can be weighed more heavily.

The extent to which an ad characteristic is considered predictive can be derived based on the covariance of the ad characteristic and the relevance scores of ads. This covariance can be calculated based on stored user interactions for all ads in the ad store 130. An ad can be assigned weight based on similarities to the ad, A, which are not considered ad characteristics. For example, the fact that an ad advertises shoes might not be considered an ad characteristic, but ads which do mention shoes might be weighed more heavily. A set of relevance scores, {r₁, r_{M}}, can be calculated or received for each ad, {a₁, . . . , a_{M}}. The relevance scores can be the actual computed relevance scores for the whole target group of each ad. Alternately, the relevance score for each ad may be calculated based only on user interactions from users within the target group of the ad A. The predicted relevance score, R_{P}, can then be calculated by a weighted average of the similar ads (i.e., R_{P}=Σwᵢrᵢ/Σwᵢ). In some embodiments, R_{P} is normalized after it is computed. The predicted relevance score, R_{P}, can be displayed to the advertiser. In some embodiments, a range of predicted relevance scores is displayed to the advertiser, rather than a single relevance score.

Some subset of the identified ad characteristics, {C₁, . . . , C_{N}} can be presented to the advertiser along with an indication of the effect of the characteristic on the predicted relevance score. For example, the social networking system 110 might identify that ads with more than 35 words perform poorly and, responsive to receiving an ad from an advertiser that contains 40 words, display a message to the advertiser that suggests shortening the text content of the ad. Also, the social networking system 110 may identify that an identified ad characteristic is correlated with poor user engagement among a specific subset of users within the target group and display an indication to the advertiser that the target group should be changed to omit the subset of users. Similarly, the social networking system 110 may identify that ads with an identified ad characteristic perform well with a subset of users and suggest that the advertiser change the target group to target that subset of users. The social networking system 110 may also automatically assign an ad a target group 133 based on determining the predicted relevance score for a number of potential target groups.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or alternate hardware components. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying a plurality of ad auctions participated in by an evaluated ad;
for each auction of the plurality of auctions:
determining a benchmark bid for the auction,
generating a normalized total bid for each ad that participated in the auction, the normalized total bid based on the benchmark bid, an estimated rate of performing a bid goal of the ad, and an organic score of the ad, and
generating a per-auction relevance score for the ad based on a comparison of the normalized total bid of the ad to normalized total bids of other ads that participated in the auction; and
generating a relevance score for the evaluated ad based on per-auction relevance scores of ads of the plurality of auctions.

2. The method of claim 1, wherein the organic score of an ad that participated in the auction is based on a social signal received from a user to whom the ad was displayed.

3. The method of claim 2, wherein the social signal is an indication of positive user feedback for the ad.

4. The method of claim 2, wherein receiving the social signal causes a social networking system to:
associate a user profile of the user with the ad; and
display an indication that the user is associated with the ad to one or more users associated with the user.

5. The method of claim 1, wherein the benchmark bid is based on advertiser specified bids of the ads that participated in the auction.

6. The method of claim 1, wherein each ad auction of the plurality of ad auctions comprises:
generating a total bid for each ad of a plurality of ads participating in the auction based on an advertiser specified bid of the ad, the estimated rate of performing a bid goal of the ad, and the organic score of the ad;
determining the ad with a largest total bid; and
displaying the ad with the largest total bid to a user.

7. The method of claim 6, wherein the benchmark bid for the auction is based on the largest total bid.

8. The method of claim 7, further comprising selecting ads to participate in an auction of the plurality of auctions based on user characteristics for the user and based on a target group of each ad, the target group specifying target user characteristics.

9. The method of claim 1 wherein the estimated rate of performing a bid goal of an ad that participated in the auction is based on stored user interactions with the ad.

10. The method of claim 1, wherein identifying the plurality of ad auctions participated in by the evaluated ad comprises:
receiving target user characteristics;
receiving a set of stored ad auctions participated in by the evaluated ad; and
identifying the plurality of ad auctions participated in by the evaluated ad based on the target user characteristics, each ad auction from the plurality of stored ad auctions from the set of stored ad auctions.

11. A method comprising:
receiving a set of user interactions for an ad, the ad having a target group, the set of user interactions including interactions with the ad from users in the target group of the ad;
generating a relevance score for the ad based on the set of user interactions;
generating a test relevance score for the ad based on a subset of the set of user interactions, the subset corresponding to users in a test target group containing fewer users than the target group of the ad; and
responsive to determining that the test relevance score is higher than the relevance score, replacing the target group of the ad with the test target group.

12. The method of claim 11 wherein:
the set of user interactions includes a plurality of social signals received from a user;
the set of user interactions includes a plurality of indications of interactions triggering an advertiser associated with the ad to pay a social networking system for placement of the ad; and
the relevance score is based on a number of social signals received and a number of indications of the interaction triggering the advertiser to pay the social networking system.

13. The method of claim 11, wherein receiving a social signal of the plurality of social signals from a user in the target group of the ad causes a social networking system to:
associate a user profile of the user with the advertiser; and
display the ad to one or more users associated with the user on the social networking system with an indication that the user is associated with the advertiser.

14. The method of claim 11, wherein the relevance score is based on user interactions with a plurality of competing ads, the competing ads participating in one or more ad auctions with the ad.

15. The method of claim 11, wherein:
the relevance score is based on a set of ad auctions in which the ad participated, each ad auction in the set of ad auctions associated with a user in the target group of the ad; and
the test relevance score is based on a subset of the set of ad auctions, the subset of ad auctions associated only with users in the test target group.

16. The method of claim 11, further comprising determining that a user is in the target group for the ad based on one or more target user characteristics of the target group and user characteristics of a user profile of the user.

17. The method of claim 11, wherein receiving a user interaction of the set of user interactions for the ad comprises:
generating a total bid for each ad participating in an ad auction, the ads participating in the ad auction including the ad for which the relevance score is generated; and
responsive to determining that the total bid of the ad is a largest total bid of the ads participating in the ad auction, displaying the ad to a user in the target group of the ad.

18. A method comprising:
receiving a plurality of ads, each ad including a digital image;
receiving a plurality of user interactions, each user interaction of the plurality of user interactions including an interaction by a user with an ad of the plurality of ads;
generating a relevance score for each ad of the plurality of ads based on the plurality of user interactions;
generating a set of image characteristics for each ad of the plurality of ads based on the digital image of the ad;
receiving a new ad, the new ad including a new digital image;
generating a set of image characteristics for the new ad based on the new digital image; and
generating a predicted relevance score for the new ad based on the image characteristics of the new ad, the relevance scores of the plurality of ads, and the image characteristics of the plurality of ads.

19. The method of claim 18, wherein the relevance score of an ad is based on a plurality of social signals and a plurality of indications of user interactions that trigger the advertiser to pay the social networking system.

20. The method of claim 18, wherein:
each user interaction of the plurality of user interactions is with an ad of the plurality of ads from a user in the target group of the ad; and
generating the predicted relevance score for the new ad is further based on a target group of the new ad and each target group of each ad of the plurality of ads.
